(19) United States
(12) Patent Application Publication
(10) Pub. No.: US 2013/0046846 A1
(43) Pub. Date: Feb. 21, 2013

(54) Methods and systems for remote data storage utilizing content addresses

(71) Applicants: W. Anthony Mason, Vancouver (CA); Roderick David Wolfe Widdowson, East Lothian (GB)

(72) Inventors: W. Anthony Mason, Vancouver (CA); Roderick David Wolfe Widdowson, East Lothian (GB)

(73) Assignee: OSR Open Systems Resources, Inc., Amherst, NH (US)

(21) Appl. No.: 13/608,852

(22) Filed: Sep. 10, 2012

Related U.S. Application Data
(63) Continuation of application No. 12/658,209, filed on Feb. 4, 2010, now abandoned.
(60) Provisional application No. 61/150,380, filed on Feb. 6, 2009.

(51) Int. Cl. G06F 15/167

(52) U.S. Cl. 709/214

(57) ABSTRACT

In one general aspect, various embodiments are directed to a method of writing a data block to a memory comprising receiving an electronic write request from an application. A content address of a first data block considering the value for the first data block. A mapping of the first data block to the content address may be written to a logical end of the local block map. The mapping may also be written to a remote block map. If the content address is not present at a local data storage, the value of the first data block may be written to the local data storage at a first location and metadata associating the content address with the first location may be written to the local data storage.

### PRIORITY CLAIM

This application claims the benefit of U.S. Provisional Patent Application 61/150,380 filed on Feb. 6, 2009, which is incorporated herein by reference in its entirety.

### BACKGROUND

Increasing numbers of computer devices utilize remote, server-side data storage, including web-based data storage. According to typical server-side storage arrangements, a service provider implements one or more network-accessible hosts. Each host usually comprises data storage hardware and one or more servers for administering the hardware. The hosts and data storage hardware may be at a single physical location, or may be distributed across multiple location. Users of the service are able to access the hosts over the network to upload and download data files. The network may be a local area network (LAN) or a wide area network (WAN), such as the Internet. Typically, the users can access the central data store from multiple computer devices, and often from any computer device having the appropriate client software and the ability to communicate on the network. The service provider may be a private enterprise providing data storage to its employees and other affiliates. Also, the service provider may be a commercial entity selling access to its storage. One example of such a commercially available remote data service is the SIMPLE STORAGE SERVICE or S3 available from AMAZON WEB SERVICES LLC.

Remote or server-side data storage has a number of advantages. For example, remote data storage is often used as a means to back-up data from client computers. Data back-up, however, is only effective if it is actually practiced. Backing up files to a remote data storage can be a tedious and time consuming task that many computer users just do not do. As more individuals store important information on their mobile telephones and personal digital assistants (PDA's), backing up these devices is becoming prudent as well.

### BRIEF DESCRIPTION OF THE FIGURES

Various embodiments of the present invention are described here by way of example in conjunction with the following figures, wherein:

FIG. 1 shows a block diagram of one embodiment of a client system architecture.

FIG. 2 shows a block diagram of one embodiment of a system comprising a client device organized according to the architecture of FIG. 1 and utilizing a local data storage and a remote data storage as a component of its data storage.

FIG. 3 illustrates one embodiment of a process flow for writing data blocks to data storage in the system of FIG. 2.

FIG. 4 illustrates one embodiment of a process flow for reading a data block using the system of FIG. 2.

### DESCRIPTION

Various embodiments are directed to systems and methods for implementing content addressable, log structured data storage schemes, which may be implemented on a single machine or across multiple machines as part of a remote storage system. In some embodiments, content addressable, log structured data storage may be used to allow client devices to utilize remote storage as their primary, bootable data storage and/or may facilitate data back-up utilizing remote data storage. In embodiments where the remote storage is used as a client's primary data storage, data may be cached at local storage, but ultimately pushed to the remote storage. In this way, valuable user data may be concentrated at the remote data source, allowing for easier data management, updating and back-up.

In various embodiments, the content addressable, log-structured nature of the data storage schemes may address existing shortcomings of remote data storage that currently make it undesirable for use as a bootable primary data storage. On such shortcoming is related to access times. Access times for remote storage are often greater than access times for local storage. On the pull or download side, a client machine may achieve acceptable access times and minimize pulls from the remote storage by locally caching data that is subject to repeated use. Further, many implementations of remote storage are configured to minimize pull times, which may increase the effectiveness of caching or even make it unnecessary.

The optimization of remote data source pull times, though, often comes at the expense of longer push times. Push times on some commercially available remote storage solutions can be between several seconds and several hours. Accordingly, it may be desirable to minimize data being pushed to remote storage. In various implementations, the content addressable, log-structured data storage described herein may address this concern. Because the data storage is content addressable, the client may not have to push a new data block if a data block with the equivalent content already exists at the remote data source. Because the data storage is log-structured, writing to or modifying the remote storage may only require pushing a new data block, if any, and pushing short modifications to one or more logs describing the new data block. Although the content addressable, log-structured data storage has certain disclosed advantages when used in a remote storage environment, it may also be used to achieve other advantages, for example, on a single machine.

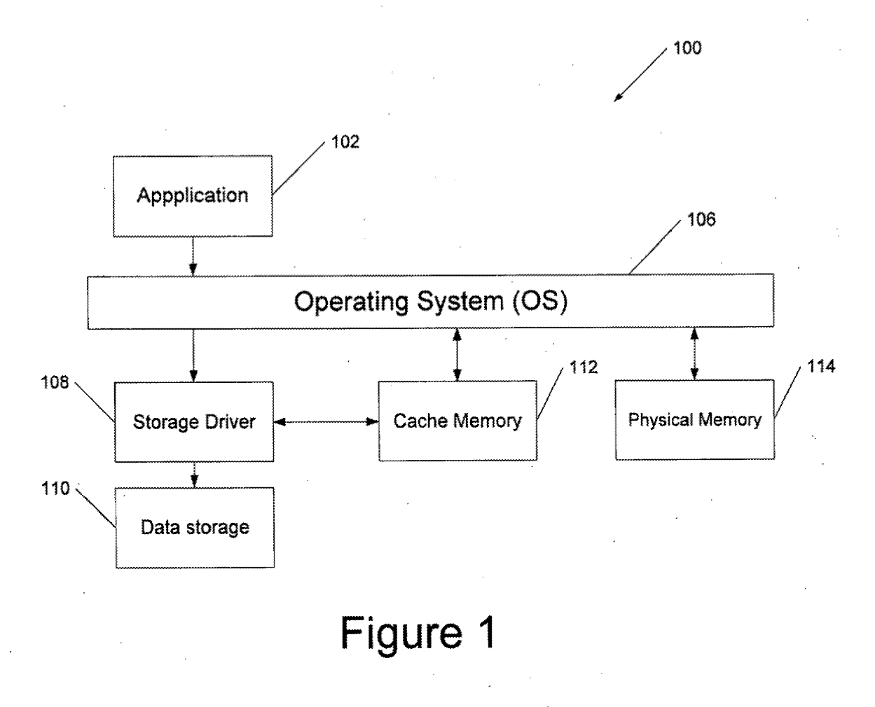

FIG. 1 shows a block diagram of one embodiment of a client system architecture 100 comprising content addressable, log-structured data storage 110. The architecture 100 may be implemented by a client computing device in a remote storage environment. For example, the data storage 110 may comprise local and remote data storage portions. The data storage 110 and the various components of the architecture 100 may be implemented utilizing software and/or hardware. For example, in addition to the data storage 110, the architecture 100 may comprise one or more examples of an application 102, an operating system 106, a storage driver 108, cache memory 112, physical memory 114 as well as other common components that are not shown.

The application 102 may include a group of one or more software components executed by a processor or processors of the client device. It will be appreciated that the architecture 100 may, in various aspects, include additional applications (not shown) that may execute sequentially or simultaneously relative to the application 102. The application 102 may perform at least one task such as, for example, providing e-mail service, providing word processing, providing financial management services, etc. Applications, such as the application 102 may perform tasks by manipulating data, which may be retrieved from the data storage 110 and/or memory 112, 114.

Interaction between the application 102 and the data storage 110 and memory 112, 114 may be facilitated by the operating system 106 and the storage driver 108. The operating system 106 may be any suitable operating system. For example, in various non-limiting embodiments, the operating system 106 may be any version of MICROSOFT WINDOWS, any UNIX operating system, any Linux operating system, OS/2, any version of Mac OS, etc. To acquire data for manipulation and output results, applications 102 may generate “read requests” and “write requests” for particular data blocks.

A data block may represent the smallest unit of data handled by the architecture 100 and/or stored at data storage 110. Logical constructs, such as files, may be expressed as one or more data blocks. Metadata may also be expressed as one or more data blocks. Data blocks may be of any suitable size, depending on the implementation of the client system 100. For example, many physical storage drives have disks with sectors that are 512 bytes. Some disks may have 520 byte sectors, leaving 512 bytes for data and 8 bytes for a checksum. Other disks, such as some SCSI disks, may have 1024 byte data blocks. Accordingly, some embodiments may utilize data blocks that are 512, 520 and/or 1024 bytes in size. Also, for example, a typical file system sector may be 4096 bytes or 4 kilobytes (kB) and, some physical storage devices, such as CD-ROM's, have sectors that are 2048 bytes (2 kB). Accordingly, 4 kB and 2 kB data blocks may be desirable in some embodiments.

The read and write requests originating from the application 102 are provided to the operating system 106. (It will be appreciated that some read and write requests may originate directly from the operating system 106.) In various embodiments, the application 102 may utilize an application program interface (API) or other library (not shown) to facilitate communication between the application 102 and the operating system 106. The operating system 106 may service read or write requests from the application 102, for example, by accessing data storage 110 through the storage driver 108, or by accessing memory 114, 112. Physical memory 114 (e.g., Random Access Memory or RAM) may include volatile or non-volatile memory with read and write times that are faster than those of the data storage 110. The operating system 106 may utilize physical memory 114 to store data that is very commonly read or written to during normal operation, thus reducing access times and increasing execution speed. Accordingly, some read or write requests from the application 102 may be handled directly from memory 112, 114. Optional cache memory 112 may be faster than physical memory 114 and may be used for a similar purpose.

Many read and write requests, however, require the operating system 106 to access data storage 110. In these instances, the operating system 106 may package read or write requests and provide them to the storage driver 108. Read requests provided to the storage driver 108 may comprise an identifier(s) of a data block or blocks to be read (e.g., a logical block identifier). Write requests provided to the storage driver 108 may comprise identifier(s) of a data block or blocks to be written, along with the data blocks to be written. The storage driver 108 may execute the read and write requests. For example, in response to a read request, the storage driver 108 may return the requested data block or blocks. In response to a write request, the storage driver 108 may write the included data block. It will be appreciated that in various embodiments, some or all of the functionality of the storage driver 108 may be implemented by the operating system 106.

Physically, the data storage 110 may include any kind of storage drive or device capable of storing data in an electronic or other suitable computer-readable format. In some embodiments, data storage 110 may include a single fixed disk drive, an array of disk drives, an array of disk drives combined to provide the appearance of a larger, single disk drive, a solid state drive, etc. Data storage 110 may be local, accessible directly to the operating system 106, or may be remote, accessible over the network, such as the Internet. In various embodiments, the data storage 110 may comprise local and remote portions.

Logically, the data storage 110 may be implemented according to a content addressable, log-structured scheme. In a log-structured organization, data blocks and metadata describing the data blocks are written to a data source sequentially. To retrieve data blocks, the metadata is consulted to determine the location of the desired data block. In content addressable schemes, each data block is described by a representation of its content (e.g., a content address). A content address for a block may be found, for example, by applying a hash algorithm to the data block. The hash algorithm may return a number, or hash, of a predetermined length. The hash represents the content of the data block. Depending on the quality of the hash algorithm used, it may be highly unlikely that two data blocks having different values will return the same content address or hash (e.g., a collision). Example hash algorithms may include SHA-0, SHA-1, SHA-2, SHA-3, MD5, etc. Different algorithms, and different versions of each algorithm may yield hashes of different sizes. For example, the SHA-2 algorithm may yield hashes of 28, 32, 48, 64 bytes or more. The likelihood may be dependent on the quality of the hash algorithm, the length of the hash, and the size of the data block to be hashed. For example, when utilizing a larger data block, it may be desirable in some circumstances to select a hash algorithm generating a longer hash.

Content addressable storage may utilize two layers of mappings. A logical block map, or block map, may link an identifier of a data block provided in a read or write request to a corresponding hash or content address. The identifier of the data block may be a name of a file or file portion, a disk offset, or other logical unit A data mapping may map the hash or content address of a data block to the data block (e.g., a physical location of the data block, or other way to access the data block). A read request received from the operating system 106 may comprise an identifier of the block or blocks to be read. The block map may be used to convert the identifier or identifiers to one or more hashes or content addresses. The data map may be used to return the identified data block or blocks given the hash or content address. A write request may comprise an identifier of and an indication of the value of a block (or blocks) to be written. The hash algorithm may be applied to the value to generate a content address. The content address may then be associated with the identifier in the block mapping. In a content addressable storage, it is possible for more than one identifier to correspond to the same content address and therefore to the same location in physical storage. For example, if two or more data blocks have the same value, only one instance of the data block may be stored at the data storage 110. Accordingly, if the content address and data block to be written are already stored at the data storage, there may be no need to re-write the data block. The block map, however, would be updated so that the identifier included in the request points to the exiting data block having the same content address.

According to various embodiments, the content addressable mapping functions may be implemented by the operating system 106, or the storage driver 108 of the architecture 100. In some embodiments where the mapping functions are implemented by the storage driver 108, their implementation may be transparent to the operating system 106 and the application 102. For example, the operating system 106 may provide disk offsets as identifiers for each data block in a read or write request. The storage driver 108 may implement the block mapping and the data mapping to return the data blocks to the operating system 106 and/or write the blocks to storage 110. In this way, the operating system 106 may believe that it is reading and writing from a local disk even if the data storage 110 comprises local and remote portions.

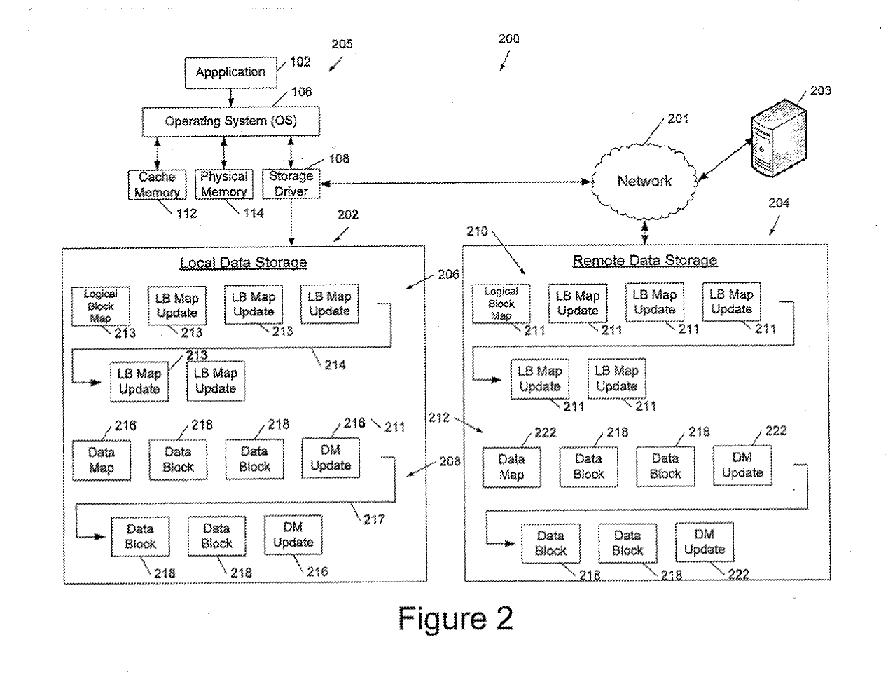

FIG. 2 shows a block diagram of one embodiment of a system 200 comprising a client device 205 organized according to the architecture 100 and utilizing a local data storage 202 and a remote data storage 204 as a component of its data storage 110. Accordingly, the data storage 110 illustrated in FIG. 1 maybe embodied by a local data storage 202 and a remote data storage 204. The local and remote data storage 202, 204 shown in FIG. 2 also illustrate a content addressable, log-structured implementation. The local data storage 202 may comprise any suitable kind of physical data storage device including, for example, a random access memory (RAM), a read only memory (ROM), a magnetic medium, such as a hard drive or floppy disk, an optical medium such as a CD or DVD-ROM or a flash memory card, etc. The remote data storage 204 may comprise any suitable kind data storage located remotely from the client 205. The remote data storage 204 may be accessible to the client via a network 201 such as, for example, the Internet. One or more servers 203 may administer the remote data storage 204. According to various embodiments, the remote data storage 204 may comprise a cloud storage system.

The local storage 202 may comprise a local logical block log, or local block log 206 and a local data log 208. The local block log 206 may comprise a local logical block map or local block map comprising local block map units 213. The local block map may implement the block mapping function of the data storage system. For example, the local block map may comprise a table or other data structure linking data block identifiers (e.g., received from the operating system 106) with corresponding content addresses (e.g., hashes). The units 213 making up the local block map may be written in sequential log-structured format. Units 213 indicating changes to the local block map may be written to the logical end of the log 206. For example, arrow 214 indicates the logical direction of updates. To find the current state of the local block map, the client system 205 (e.g., via device driver 108) may either start at the logical beginning of the log 206 and consider each recorded change or start at the logical end of the log 206 and continue until the most recent change to the mapping of a desired data block is found.

The local data log 208 may comprise a data map units 216 and data blocks 218. The data map units 216 and data blocks 218 may be commingled in a log-structured format. It will be appreciated, however, that, in some embodiments, data blocks 218 may instead be commingled with the local block log 206 or may be included in a separate log (not shown). The data map units 216 may, collectively, make up a local data map which may map various content addresses to data units. Generally, the local data log may indicate which data blocks are cached at the local data storage 202. If a data block is not cached at the local data storage 202, then the client device 205 may retrieve the data block at the remote data storage, as described below.

The remote data source 204 may comprise a remote logical block log 210 and a remote data section 212. The remote block log 210 may comprise remote block log units 211, which may be stored at the remote data source in a log-structured fashion. Collectively, the remote block log units 211 may make up a remote block log. The remote block log may be substantially similar to the local block log in most circumstances. That is, data block identifiers utilized by the operating system 106 should generally map to the same content address at the local block map and the remote block map. For example, the local block map may serve as a local cache copy of the remote block map. If the local block map is lost, it may be substantially replaced by pulling the remote block map.

The remote data section 212 may comprise data blocks 218, which may be organized in any suitable fashion. In the embodiment pictured in FIG. 2, the data blocks 218 are organized in a log-structured fashion with remote data map units 222 making up a remote data map that describes the position of each data block in the log by its content address. Any other suitable method of indexing the data blocks 218 by content address may be used, however. For example, in various embodiments, the data blocks 218 may be stored hierarchically with each layer of the hierarchy corresponding to a portion of the content address (e.g., the first x bits of the content address may specify a first hierarchy level, the second x bits may specify a second hierarchy level, and so on). Also, in other embodiments, the data blocks 218 may be stored according to a SQL database or other organization structure indexed by content address.

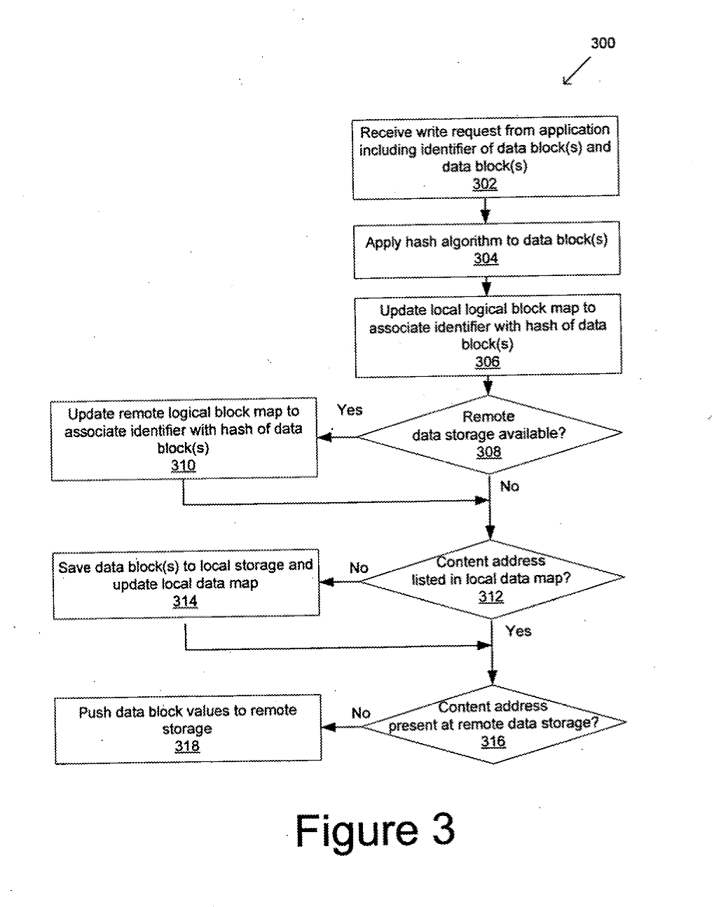

FIG. 3 illustrates one embodiment of a process flow 300 for writing data blocks to data storage in the system 200. Although the process flow 300 is described in the context of a write request regarding a single data block, it will be appreciated that the steps could be easily modified for write requests comprising more than one data block. Referring to the process flow 300, a write request may be generated (302). The write request may include an identifier of a data block (e.g., a disk offset) and a value for the data block. According to various embodiments, the write request may originate from an application 102, be formatted by the operating system 106 and forwarded to the storage driver 108. A hash algorithm may be applied to data block value included in the write request (e.g., by the storage driver 108) to generate a content address (304). The storage driver 108 may update the local block map to associate the identifier with the content address corresponding to the data block value (306). This may be accomplished, for example, by writing a local block map unit 213 comprising the update to the end of the local block log 206. If the remote data storage 204 is available (308), then the remote block map may also be updated (310), for example, by pushing a remote block map unit 211 indicating the association to the end of the remote block log 210. If the remote data storage 204 is not available, the local block map unit 213 may be marked as un-pushed.

The storage driver 108 may traverse the local data map to determine if the content address is listed in the local data map (312). If the content address is not listed in the local data map, it may indicate that no existing data block on the local data storage 202 has the same value as the data block to be written. Accordingly, the data block to be written may be written to the end of the local data log 208 along with a local data map unit 216 mapping the content address of the data block to be written to its physical location in the log 208 (314). According to various embodiments, the local copy of the data block may be maintained, at least until the client 205 is able to verify that the data block has been correctly written to the remote data storage 204.

The storage driver 108 may also determine if a data block having the same content address as the data block to be written is present at the data section 212 of the remote data storage 204 (316). In embodiments where the data section 212 is log structured, this may involve traversing a remote data map comprising remote data map units 222. In embodiments where the data units are stored hierarchically at the data section 212, this may involve examining a portion of the hierarchy corresponding to the content address to determine if a value is present. In embodiments where the data units are stored in an indexed fashion (e.g., at a SQL server), it may involved performing a search using the content address as an index. If no data block having the same content address as the data block to be written is present at the remote data storage 204, then the value of the data block to be written may be pushed to the remote data storage 204, if it is available. If the remote data storage is not available, then the local data log may be updated to indicate that the data block to be written has not be pushed to the local data storage 204.

The availability of the remote data storage 204 may, in various embodiments, depend on the network connectivity of the client 205. For example, when the client is able to communicate on the network 201, the remote data storage 204 may be available. It will be appreciated that when the client logs on to the network 201 after having been disconnected for one or more write requests, there may be one or more data blocks 218 and local block map units 213 that have not been pushed to the remote data storage 204. In this case, for each local block map unit 213 that is un-pushed, step 310 may be performed to update the remote block map. Likewise, for each data block 218 that is un-pushed, steps 316 and 318 may be performed to first determine if the data block 218 is present at the remote data storage 204 and, if not, push the data block 218 to the remote data storage 204.

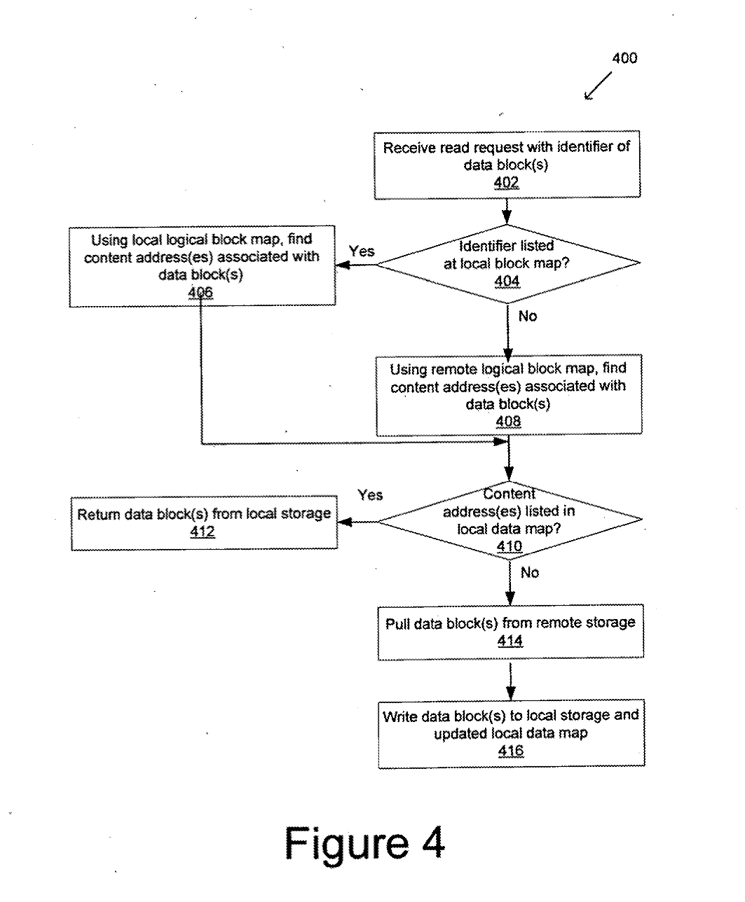

FIG. 4 illustrates one embodiment of a process flow 400 for reading a data block using the system 200. Although the process flow 400 is described in the context of a read request regarding a single data block, it will be appreciated that the steps could be duplicated for read requests comprising more than one data block. Referring to the process flow 400, a read request may be generated (402). The read request may comprise an identifier for the data block to be read. If the identifier is listed in the local block map (404), then the local block map may be utilized to find the content address associated with the identifier (406). If the identifier is not listed in the local block map, then the remote block map may be used to find the content address associated with the identifier (408). If the identifier is not listed in the local block map, and the remote data storage 204 is not available, the read request may fail. After obtaining the content address corresponding to the requested data block, it may be determined if the content address appears in the local data map (410). If so, then the requested data block may be returned from local storage 202 (412). If not, then the requested data block may be pulled from remote data storage 204, utilizing the content address (414). Optionally, after being pulled from the remote data storage, the data block may be written to the local data log 208 and the local data map may be updated accordingly (416). This may allow the data block to be accessed locally for future reads.

The methods and systems described herein may provide several advantages. For example, as described above, data back-up may be facilitated. The remote data storage 204 may serve as back-up storage. Because the client device 205 automatically uploads changes to data blocks to the remote data storage 204, the back-up is not overly burdensome on users of the client device 205 and does not require extra diligence on the part of the users. In various embodiments, the remote data storage 204 may be ordinarily inaccessible to the client device 205. In these embodiments, a user of the client device may affirmatively log into to remote data storage 204 to perform a back-up.

The methods and systems described herein may also promote device accessibility. For example, the remote block map may correspond to a particular client device 205. Accordingly, a user of the client device 205 may log into the remote data storage 204 on a new device, access the remote block map, and re-create the client device 205 on the new device. With access to the block map and functionality for implementing the methods and systems above, the new device may boot directly from the remote storage 204 to implement the device. In embodiments where other data is present on the new device, functionality may be provided to hash and log this data to form a local data map. Because many data blocks are common across different devices that run similar operating systems and applications, this may minimize the number of data blocks that must be pulled from the remote data storage 204. To implement this functionality at a new device, a user may be provided with a USB drive or other storage device comprising, for example, a version storage driver 108, authentication credentials to the remote storage device 204 and/or a block map corresponding to the remote block map. The ability to re-create the client device 205 on a new machine may provide a number of benefits. For example, in the event of the loss of a client device 205, a clone of the device could be created on a new device by simply implementing the storage driver 108 and accessing the remote block map. Also, for example, a user may be able to access their client device 205 while traveling without having to physically transport the device.

Various other advantages of the disclosed systems and methods arise from the fact that client device 205 data is present at the remote data storage 204. For example, data at the remote data store 204 may be scanned for viruses. Because any viruses that are present would be executing at the client device 205 and not at the remote data store 204, it may be difficult for a virus to hide its existence at the remote data store 204. Data blocks at the remote data store 204 that are found to include a virus signature may be deleted and/or flagged as potentially infected.

Still other advantages of the disclosed systems and methods arise from embodiments where an enterprise stores data from many client devices 205 at a single remote data store 204. For example, each individual client device 205 may have a unique remote block map stored at remote block map log 210. The remote data section 212 of the remote data store 204 may be common to all client devices 205 of the enterprise (e.g., computer devices on a company's network, mobile phones on a mobile carrier's network, etc.). Because many data blocks are common on similar computer devices, implementing a common remote data section 212 may save significant storage space. In addition, enterprise administrators may be able to update applications on some or all of the client devices 205 by updating or changing the appropriate data blocks 218 at the remote data section 212 and updating the remote block log for each client device 205. When each client device 205 re-authenticates itself to the remote data storage 204, the changes to the block log may be downloaded, completing the update. Also, when remote data from multiple client devices 205 is commingled, processing required to perform virus checking may be significantly reduced because duplicated data blocks may only need to be scanned once.

It will be appreciated that a client device 205 may be any suitable type of computing device including, for example, desktop computers, laptop computers, mobile phones, palm top computers, personal digital assistants (PDA's), etc. As used herein, a “computer,” “computer system,” “computer device,” or “computing device,” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

The term “computer-readable medium” as used herein may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary.

It is to be understood that the figures and descriptions of embodiments of the present invention have been simplified to illustrate elements that are relevant for a clear understanding of the present invention, while eliminating, for purposes of clarity, other elements, such as, for example, details of system architecture. Those of ordinary skill in the art will recognize that these and other elements may be desirable for practice of various aspects of the present embodiments. However, because such elements are well known in the art, and because they do not facilitate a better understanding of the present invention, a discussion of such elements is not provided herein.

It can be appreciated that, in some embodiments of the present methods and systems disclosed herein, a single component can be replaced by multiple components, and multiple components replaced by a single component, to perform a given function or functions. Except where such substitution would not be operative to practice the present methods and systems, such substitution is within the scope of the present invention. Examples presented herein, including operational examples, are intended to illustrate potential implementations of the present method and system embodiments. It can be appreciated that such examples are intended primarily for purposes of illustration. No particular aspect or aspects of the example method, product, computer-readable media, and/or system embodiments described herein are intended to limit the scope of the present invention.

It should be appreciated that figures presented herein are intended for illustrative purposes and are not intended as design drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the appended claims.

1-20. (canceled)

21. A remote data storage system servicing a plurality of remote clients, the remote data storage system comprising:
at least one server, wherein the at least one server comprises:
a plurality of remote block maps, wherein each of the plurality of remote block maps corresponds to one of the plurality of remote clients, and wherein each of the plurality of remote block maps comprises a plurality of mappings with each mapping associating an identifier of a data block to a corresponding content address describing the data block; and
a log-structured remote data log comprising data blocks organized by content address; and
wherein the at least one server is programmed to:
receive a read request from a first remote client selected from the plurality of remote clients, wherein the read request indicates a first identifier;
based on a first remote block map selected from the plurality of remote block map and corresponding to the first remote client, identify a first content address corresponding to the first identifier;
retrieve a first data block from the log-structured remote data log, wherein the first data block corresponds to the first content address;
transmit the first data block to the first remote client in response to the read request.

22. The system of claim 21, wherein the at least one server is further programmed to update at least one application on the plurality of remote clients, wherein the updating comprises:
modifying a plurality of data blocks stored at the log-structured remote data log; and
modifying at least one mapping stored at each of the plurality of block maps.

23. The system of claim 22, wherein the at least one server is further programmed to:
after modifying the at least one mapping stored at each of the plurality of block maps, transmitting the updated first remote block map to the first remote client.

24. The system of claim 21, wherein the at least one server is further programmed to scan the log-structured remote data log for malicious software.

25. The system of claim 24, wherein the scanning the log-structured remote data log for malicious software comprises scanning for viruses.

26. The system of claim 21, wherein the at least one server is further programmed to:
receive a write request from the first remote client, wherein the write request comprises a second data block and indicates a second identifier identifying the second data block;
deriving a second content address from the second data block;
write a new mapping to the first remote block map selected from the plurality of block maps and associated with the first remote client, wherein the new mapping associates the second identifier with the second content address;
conditioned upon the second data block not existing in the log-structured remote data log, write the second data block to the log-structured remote data log.

27. The system of claim 26, wherein deriving the second content address comprises applying a hash algorithm to the second data block.

28. The system of claim 27, wherein the hash algorithm is selected from the group consisting of SHA-0, SHA-1, SHA-2, SHA3 and MD5.

29. The system of claim 21, wherein the plurality of mappings at each of the plurality of remote block maps are arranged within the respective remote block maps in chronological order based on when each mapping was written to the local block map.

30. The system of claim 21, wherein the first data block is at least one size selected from the group consisting of 512 bytes, 520 bytes, 1024 bytes, 2048 bytes and 4096 bytes.

31. The system of claim 21, wherein at least a portion of the remote block maps are organized at the at least one server according to a log-structured format.

32. The system of claim 21, wherein the at least one server is further programmed to boot the first remote client.

33. A computer-implemented method for servicing a plurality of remote clients, the remote data storage method comprising:
receiving, by a computer system, a read request from a first remote client selected from the plurality of remote clients, wherein the read request indicates a first identifier, wherein the computer system comprises at least one processor and associated memory;
based on a first remote block map corresponding to the first remote client, identifying by the computer system a first content address corresponding to the first identifier, wherein the first remote block map is selected from a plurality of remote block maps stored remote from the plurality of remote clients, and wherein each of the plurality of remote block maps comprises a plurality of mappings, with each mapping associating an identifier of a data block to a corresponding content address describing the data block;
retrieving, by the first computer system, a first data block from a log-structured remote data log, wherein the first data block corresponds to the first content address, and wherein the remote data log comprises data blocks organized by content address;
transmitting, by the first computer system, the first data block to the first remote client in response to the read request.

34. A portable data storage device for re-creating a client device on a computer machine, the portable storage device comprising a computer readable medium comprising thereon:
an authentication credential; and
a storage driver, wherein, when executed by the computer machine, the storage driver causes the computer machine to:
provide the authentication credential to a remote data storage system;
receive from the remote data storage system a local block map corresponding to the client device, wherein the local block map comprises a plurality of mappings with each mapping associating an identifier of a data block to a corresponding content address describing the data block; and
receive a read request from an application executing on the computer machine, wherein the read request indicates a first identifier;
based on the local block map, identify a first content address corresponding to the first identifier;
retrieve a first data block corresponding to the first content address; and
generate a reply to the read request comprising the first data block.

35. The portable storage device of claim 34, wherein the storage driver further causes the computer machine to receive from the remote data storage system a log-structured local data log comprising a plurality of data blocks organized by content.

36. The portable storage device of claim 35, wherein retrieving the first data block comprises retrieving the first data block from the local data log.

37. The portable storage device of claim 34, wherein retrieving the first data block comprises retrieving the first data block from the local data log comprises retrieving the first data block from a remote data log located at the remote data storage system.

38. The portable storage device of claim 34, further comprising an existing local block map, wherein receiving the local block map consists of receiving from the remote data storage system at least one update to the existing local block map.

39. The portable storage device of claim 34, wherein the storage driver further causes the computer machine to:
receive an electronic write request from the application, wherein the write request comprises a second identifier indicating a second data block and the second data block;
derive a content address of the second data block;
write a mapping to a logical end of the local block map, wherein the mapping maps the identifier of the second data block to the content address of the second data block;
write the mapping to a remote block map;
based on the content address of the second data block, determine if the second data block is present at the computer machine;
conditioned upon the second data block not being present at the computer machine:
write the second data block to a local data log of the computer device at a first location; and
write to the local data log metadata associating the content address with the first location.

40. A method for re-creating a client device on a computer machine, the method comprising:
receiving, by a computer system, an authentication credential from a storage driver executed by a client device and provided to the client device from a portable storage device, wherein the computer device comprises at least one processor and operatively associated memory;
provide, by the computer system and to the client device, a local block map corresponding to the client device, wherein the local block map comprises a plurality of mappings with each mapping associating an identifier of a data block to a corresponding content address describing the data block;
receive, by the computer system and from the client device, a read request comprising a first content address selected from the local block map; and
provide, by the computer system and to the client device, a first data block corresponding to the first content address.
